(19) United States
(12) Patent Application Publication
(10) Pub. No.: US 2011/0143710 A1
(43) Pub. Date: Jun. 16, 2011

(54) SYSTEMS AND METHODS TO FACILITATE ELECTRONIC PAYMENTS

(75) Inventor: Ron HIRSON, San Francisco, CA (US)

(73) Assignee: BOKU, INC., San Francisco, CA (US)

(21) Appl. No.: 12/961,393

(22) Filed: Dec. 6, 2010

Related U.S. Application Data
(60) Provisional application No. 61/287,174, filed on Dec. 16, 2009.

(51) Int. Cl. H04W 4/24; H04W 4/12; H04W 12/06; G06Q 20/00

(52) U.S. Cl. 455/408; 455/414.1; 455/411; 705/44

(57) ABSTRACT

Systems and methods are provided to facilitate online transactions via mobile communications. In one aspect, a system includes an interchange and a data storage facility to associate an account identifier with a telephone number. The interchange includes a common format processor and a plurality of converters to interface with a plurality of different controllers of mobile communications. The converters are to communicate with the controllers in different formats and to communicate with the common format processor in a common format. The common format processor is to instruct a first controller of the controllers, via a first converter of the converters, to transmit a message to a telephone at the telephone number to confirm a transaction to fund the account identified by the account identifier, to transmit, via the first converter, one or more premium messages to the telephone to collect funds, and to add the funds to the account.

### CROSS-REFERENCE TO RELATED APPLICATIONS

The present application claims the benefit of Provisional U.S. Patent Application Ser. No. 61/287,174, filed Dec. 16, 2009 and entitled “Systems and Methods to Facilitate Electronic Payments,” the disclosure of which is hereby incorporated herein by reference.

### FIELD OF THE TECHNOLOGY

At least some embodiments of the disclosure relate to mobile communications in general and, more particularly but not limited to, mobile communications to facilitate online transactions.

### BACKGROUND

Short Message Service (SMS) is a communications protocol that allows the interchange of short text messages between mobile telephone devices. SMS messages are typically sent via a Short Message Service Center (SMSC) of a mobile carrier, which uses a store-and-forward mechanism to deliver the messages. When a mobile telephone is not reachable immediately for the delivery of the message, the SMSC stores the message for later retry.

SMS messages can be sent via gateways. Some gateways function as aggregators. An aggregator typically does not have the capacity to deliver the messages directly to the mobile phones. An aggregator typically interfaces with and relies upon the SMSC of a mobile carrier to deliver SMS messages.

Some gateways function as providers that are capable of sending text messages to mobile devices directly, without going through the SMSC of other mobile operators.

Text messaging between mobile telephones can also be performed using other protocols, such as SkyMail and Short Mail in Japan.

Some mobile carriers provide email gateway services to allow text messages to be sent to mobile phones via email. For example, a non-subscriber of the mobile carrier may send a message to an email address associated with a mobile phone of a subscriber of the mobile carrier to have the message delivered to the mobile phone via text messaging.

Emails can also be sent to mobile telephone devices via standard mail protocols, such as Simple Mail Transfer Protocol (SMTP) over Internet Protocol Suite (commonly TCP/IP, named from two of the protocols: the Transmission Control Protocol (TCP) and the Internet Protocol (IP)).

Short messages may be used to provide premium services to mobile phones, such as news alerts, ring tones, etc. The premium content providers may send the messages to the SMSC of the mobile operator using a TCP/IP protocol, such as Short Message Peer-to-peer Protocol (SMPP) or Hypertext Transfer Protocol, for delivery to a mobile phone; and the mobile phone is billed by the mobile operator for the cost of receiving the premium content.

Premium services may also be delivered via text messages initiated from the mobile phone. For example, a televoting service provider may obtain a short code to receive text messages from mobile phones; and when the user sends a text message to the short code, the mobile carrier routes the message to the televoting service provider and charges the user a fee, a portion of which is collected for the televoting service provider.

### SUMMARY OF THE DESCRIPTION

Systems and methods are provided to facilitate online transactions via mobile communications. Some embodiments are summarized in this section.

In one aspect, a system includes a data storage facility to store and associate an account identifier of a user with a telephone number of the user. In one embodiment, the account identifier is to identify an account of the user at a payment intermediary service and to include an email address of the user. The system further includes an interchange coupled with the data storage facility. The interchange includes a common format processor and a plurality of converters to interface with a plurality of different controllers of mobile communications. The converters are configured to communicate with the controllers in different formats; and the converters are configured to communicate with the common format processor in a common format.

In one embodiment, the common format processor is configured to instruct a first controller of the controllers, via a first converter of the converters, to transmit a message to a telephone at the telephone number of the user. The message prompts the user to confirm a transaction to fund the account via the telephone. In response to the transaction being confirmed via communicating with the telephone, the common format processor is to transmit, via the first converter, one or more premium messages to the telephone at the telephone number to collect funds through a telecommunication carrier of the telephone and to add the funds to the account of the user at the payment intermediary service.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows a system to facilitate online transactions according to one embodiment.

FIG. 2 shows an interchange to route messages according to one embodiment.

FIG. 3 shows a message processor according to one embodiment.

FIG. 4 shows a method to facilitate an online transaction using an interchange according to one embodiment.

FIG. 5 illustrates a user interface to associate an account with a telephone number according to one embodiment.

FIG. 6 illustrates another user interface to associate an account with a telephone number according to one embodiment.

FIG. 7 illustrates a user interface to initiate a payment transaction according to one embodiment.

FIG. 8 illustrates a user interface to initiate a payment request according to one embodiment.

FIG. 9 illustrates a user interface to confirm a payment request according to one embodiment.

FIG. 10 illustrates a user interface to confirm the completion of a payment transaction according to one embodiment.

FIG. 11 illustrates a way to redirect a payment confirmation according to one embodiment.

FIG. 12 illustrates a user interface to receive payment options according to one embodiment.

FIG. 13 shows a method to process an online payment according to one embodiment.

FIG. 14 shows another method to facilitate a payment transaction according to one embodiment.

FIG. 15 shows a system to obtain funds according to one embodiment.

FIG. 16 shows a method to process a payment request according to one embodiment.

FIG. 17 shows a method to fund an account according to one embodiment.

FIG. 18 shows a data processing system, which can be used in various embodiments.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, an interchange is used to interface with a plurality of different controllers of mobile communications, such as SMS messages. The interchange can be used to associate account information with phone numbers to facilitate electronic payments via mobile devices, such as cellular phones. The interchange is configured to communicate with the mobile phones through the different controllers to provide security and convenience for online transactions.

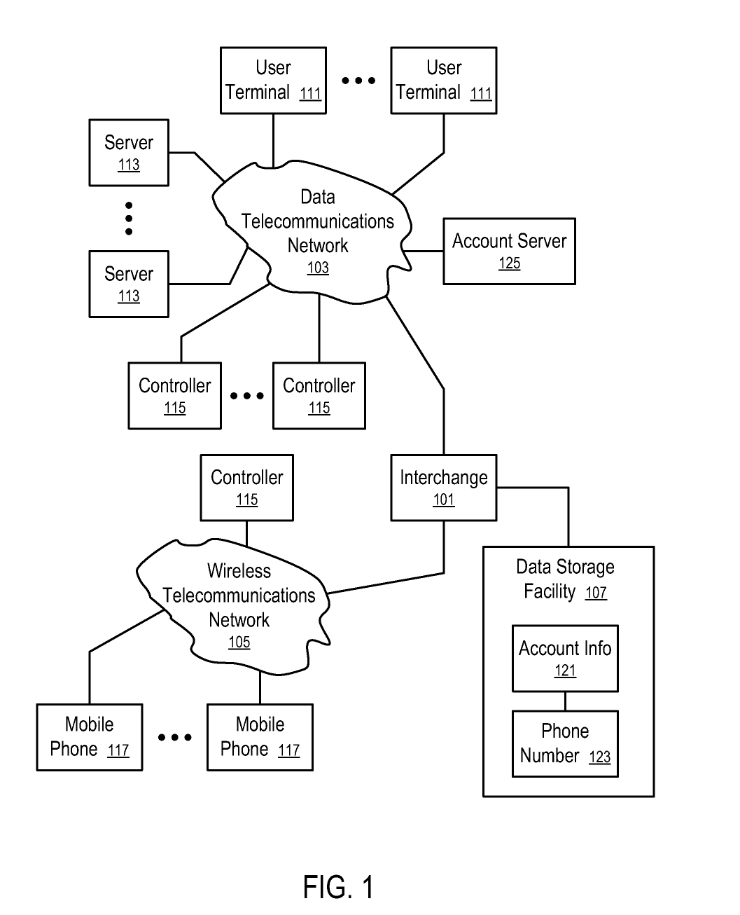

FIG. 1 shows a system to facilitate online transactions according to one embodiment. In FIG. 1, an interchange (101) is provided to interface with a plurality of different controllers (115) for communications with the mobile phones (117) over the wireless telecommunications network (105).

In FIG. 1, a data storage facility (107) stores user account information (121) and the corresponding phone numbers (123) of the mobile phones (117). The interchange (101) is coupled with the data storage facility (107) to communicate with the mobile phones (117) at the corresponding phone numbers (123) to confirm operations that are performed using the account information (121). Since the account information (121) is secured by the interchange (101), the account information (121) can be used to pay for products and services offered by the servers (113) of various merchants, without being revealed to the merchants.

In one embodiment, the server (113) offers products and/or services adapted for a virtual world environment, such as an online game environment, a virtual reality environment, etc. The products may be virtual goods, which can be delivered via the transmission of data or information (without having to physically deliver an object to the user). For example, the virtual goods may be a song, a piece of music, a video clip, an article, a computer program, a decorative item for an avatar, a piece of virtual land in a virtual world, a virtual object in a virtual reality world, etc. For example, an online game environment hosted on a server (113) may sell services and products via points or virtual currency, which may be consumed by the user while engaging in a game session. For example, a virtual reality world hosted on a server (113) may have a virtual currency, which may be used by the residents of the virtual reality world to conduct virtual commerce within the virtual reality world (e.g., buy virtual lands, virtual stocks, virtual objects, services provided in the virtual reality world, etc). In other embodiments, the server (113) may also offer physical goods, such as books, compact discs, photo prints, postcards, etc.

In FIG. 1, the interchange (101) may communicate with different controllers (115) of mobile communications via different networks (e.g., 105 and 103) and/or protocols. The interchange (101) processes the requests in a common format and uses a set of converters for communications with the different controllers (115) respectively.

For example, the controllers (115) may be different aggregators, providers and/or SMSCs of different mobile carriers. Based on the phone numbers (123), the interchange (101) interfaces with the corresponding controllers (115) to communicate with the mobile phones (117) via text messaging to confirm the operations related to the corresponding account information (121), such as bank accounts, credit card numbers, charge card numbers, etc.

In FIG. 1, the user terminals (111) may use a unified interface to send requests to the interchange (101). For example, a web site of the interchange (101) may be used to receive the account information (121) from the web browsers running in the user terminals (111). The user terminals (111) are typically different from the mobile phones (117). However, in some embodiments, users may use the mobile phone (117) to access the web and submit the account information (121). Alternatively, the users may use the mobile phone (117) to submit the account information (121) to the interchange (101) via text messaging, email, instant messaging, etc.

The use of the mobile phones (117) in the confirmation of activities that involve the account information (121) increases the security of the transaction, since the mobile phones (117) are typically secured in the possession of the users.

Further, in one embodiment, the interchange (101) may use the phone bills of the mobile phones (117) to pay for purchases, in order to use the account information (121) to pay for the phone bills, and/or to deposit funds into the accounts identified by the account information (121) by charging on the phone bills of the corresponding mobile phones (117). In some embodiments, the accounts identified by the account information (121) are hosted on the data storage facility (107). In other embodiments, the accounts are hosted on the account servers (125) of financial institutions, such as banks, credit unions, credit card companies, etc.

In one embodiment, once the account information (121) is associated with the mobile phones (117) via their phone numbers (123) stored in the data storage facility (107), the users may use the user terminals (111) to access online servers (113) of various merchants or service providers to make purchases. From the user terminals (111), the users can use the accounts identified by the account information (121) to make the payment for the purchases, without revealing their account information (121) to the operators of the servers (113).

In one embodiment, the mobile phones (117) are used by the corresponding users to make payments and/or manage funds, such as for making purchases in various websites hosted on the servers (113) of merchants and service providers and/or for transferring funds to or from an account identified by the account information (121), such as phone bills of land-line telephone services, credit card accounts, debit card accounts, bank accounts, etc., or an account hosted on the data storage facility (107) or telecommunication accounts of the mobile phones (117) with telecommunication carriers. The mobile phones (117) are used to confirm and/or approve the transactions associated with the account identified by the account information (121) (or other accounts). The interchange (101) interfaces the mobile phones (117) and the servers (113) to confirm and/or approve transactions and to operate on the account identified by the account information (121) (and/or other accounts associated with the phone number (123)).

For example, the user terminal (111) may provide the phone numbers (123) to the servers (113) to allow the servers (113) to charge the account identified by the account information (121) associated with the phone number (123). The interchange (101) sends a message to the mobile phone (117) via the phone number (123) to confirm the payment request. Once the payment is confirmed or approved via the corresponding mobile phone (117), the interchange (101) charges the account identified by the account information (121) (e.g., by communicating with the account server (125) on which the corresponding accounts are hosted) and pays the server (113) on behalf of the user, using the funds obtained from the corresponding account identified by the account information (121).

In one embodiment, the user terminal (111) may not even provide the phone number (123) to the server (113) to process the payment. The server (113) may redirect a payment request to the interchange (101), which then prompts the user terminal (111) to provide the phone number (123) to the web site of the interchange (101) to continue the payment process.

For example, the server (113) may redirect the payment request to the web site of the interchange (101) with a reference indicating the purchase made via the user terminal (111). The interchange (101) can use the reference to subsequently complete the payment with the server (113) for the purchase, after receiving the phone number (123) directly from the user terminal (111) to confirm the payment via the mobile phone (117).

In some embodiments, instead of directly providing the phone number (123) to identify the account information (121), the user may provide other information to identify the phone number (123), such as an account identifier of the user assigned to the user for obtaining the services of the interchange (101).

In one embodiment, the account information (121) is pre-associated with the phone number (123) prior to the payment request. The account information (121) may be submitted to the interchange (101) via the user terminal (111) or the mobile phone (117) via a secure connection.

Alternatively, the user may supply the account information (121) to the interchange (101) at the time the payment request is submitted from the user terminal (111) to the interchange (101). Alternatively, the user may supply the account information (121) to the interchange (101) at the time the user responds to the confirmation message for the payment request.

In some embodiments, the user may supply the account information (121) after a transaction using funds collected via the telecommunication carrier of the mobile phone (117) at the phone number (123). For example, after the transaction, the interchange (101) may send an invitation message, such as a text message to the mobile phone (117) at the phone number (123), to the user to invite the user to register with the interchange (101) and provide the account information (121). The user may register with the interchange (101) via the mobile phone (117) (e.g., by a replying text message), or via a web page of the interchange (101) (e.g., using a link and/or a unique code provided in the invitation message).

After the user registers with the interchange (101) (e.g., via the mobile phone (117) and by providing the account information (121)), the user may create a customized personal identification number (PIN) or receive a PIN for enhanced security. Using the PIN, the user may use the account information (121) to complete an online transaction without having to confirm and/or approve a transaction using the mobile phone (117). In some embodiments, the PIN may be used to reduce unwanted messages to the mobile phone (117). For example, once the phone number (123) and the account information (121) are associated with a PIN, the interchange (101) may require the user of the user terminal (111) to provide the correct PIN to initiate the payment process. Thus, a spammer having only the phone number (123) (or a different user mistakenly using the phone number (123)) may not successfully use the user terminal (111) to request the interchange (101) to send confirmation messages to the mobile phone (117) protected by the PIN. In some embodiments, the interchange (101) may offer further incentives to the user for registering with the interchange (101), such as reduced fees, discounts, coupons, free products and services, etc.

In one embodiment, once the account information (121) is associated with the phone number (123) in the data storage facility (107), the user does not have to resubmit the account information (121) in subsequent payment requests.

By delegating the payment task to the interchange (101) and securing the account information (121) in the data storage facility (107), the system as shown in FIG. 1 can increase the security of using the account information (121) in an online environment.

In some embodiments, the interchange (101) can also fulfill the payment requests using the funds collected via the phone bill of the phone numbers (123). The interchange (101) can collect the funds via sending premium messages to the mobile phones (117) at the phone numbers (123), after receiving confirmation from the mobile phone (117).

For example, after the confirmation or approval message is received from the mobile phone (117), the interchange (101) performs operations to collect funds via the phone bill of the phone number (123). The interchange (101) may calculate the required premium messages to bill to the mobile phone (117). For example, mobile terminated premium SMS messages may have a predetermined set of prices for premium messages. The interchange (101) determines a combination of the premium messages that has a price closest to the amount required by the transaction, and sends this combination of premium messages to the mobile phone (117). For example, mobile originated premium SMS messages may also have a predetermined set of prices for premium messages. The interchange (101) can calculate the set of messages required for the transaction and transmit a text message to the mobile phone (117) of the user to instruct the user to send the required number of premium messages to provide the funds.

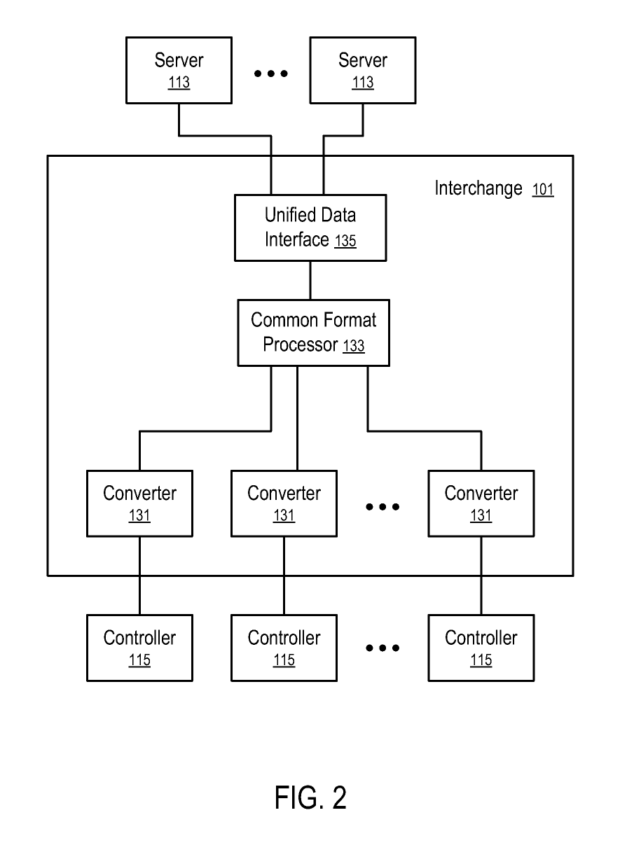

FIG. 2 shows an interchange to route messages according to one embodiment. In FIG. 2, the interchange (101) includes a unified data interface (135) for interaction with the servers (113). The servers (113) may redirect the payment requests to the interchange (101) to allow the interchange (101) to subsequently communicate with the user to process the payment request, including obtaining payment options and identifying user accounts (123), before returning to communicating with the server (113). Alternatively, the servers (113) may collect account related information (e.g., the phone number of the user) to request payment from the interchange (101).

In FIG. 2, the interchange (101) includes a common format processor (133), which processes various payment options in a common format. In one embodiment, the common format processor (133) can handle the payments via mobile terminated text message, mobile originated text message, operator bill, credit card, stored value account, and other online payment options. The common format processor (133) determines the actual amount that is to be billed to the user, based on the payment options (e.g., mobile terminated premium SMS, mobile originated premium SMS, operator billing, credit cards, etc.), and selects a converter (131) to communicate with a corresponding controller (115).

Different converters (131) are configured to communicate with corresponding controllers (115) in different languages and protocols. The converters (131) perform the translation between the common format used by the common format processor (133) and the corresponding formats used by the controllers (115).

The use of the common format processor (133) simplifies the structure of the interchange (101) and reduces the development effort required for the interchange (101) to interface with the increasing number of different controllers, such as SMSC, mobile providers, aggregators, gateways, etc.

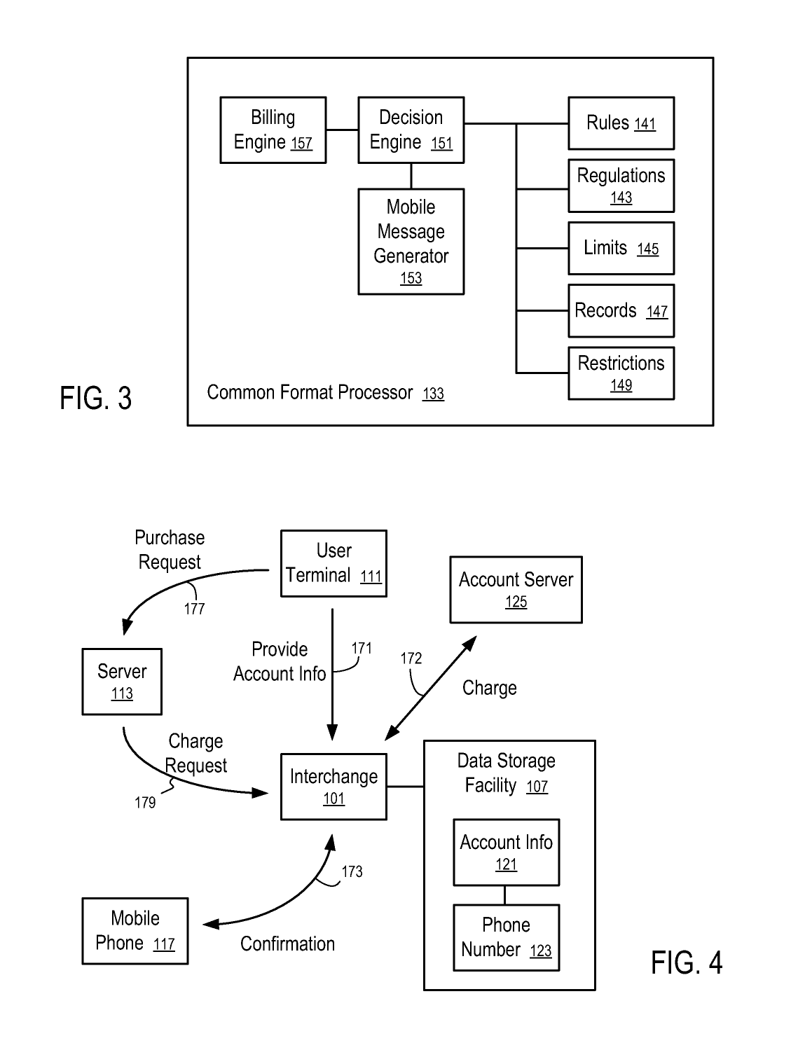

FIG. 3 shows a message processor according to one embodiment. In FIG. 3, the common format processor (133) includes a billing engine (157) that calculates the amount to be billed to the user, by adding or subtracting transaction costs for different billing methods, such as mobile terminated text message, mobile originated text message, operator billing, credit card, stored value account, and other online payment options.

In one premium message billing method, the interchange (101) sends mobile terminated premium SMS messages to the mobile phone (117) to bill the user, or requests the mobile phone (117) to send mobile originated premium SMS messages to a short code representing the interchange (101).

In one operator billing method, the interchange (101) directly sends a message to the mobile carrier of the mobile phone (117) to bill the amount on the phone bill of the mobile phone (117), without having to send a premium message to the mobile phone (117).

The common format processor (133) includes a decision engine (151) which decides how to generate a set of one or more messages to the mobile phone (117) based on a set of rules (141), regulations (143), limits (145), records (147) and restrictions (149).

For example, different countries have different regulations (143) governing the mobile communications with the mobile phones (117). For example, different mobile carriers have different rules (141) regarding premium messages. For example, past transaction records (147) can be used to monitor the transactions to discover suspected fraudulent activities. For example, parental limits (145) and merchant restrictions (149) can be imposed.

Based on results of the decision engine (151), the mobile message generator (153) generates one or more messages to communicate with the mobile phone (117) about the transaction (e.g., a request to collect funds via the phone bill of the user for a payment request, or for deposit into an account identified by the account information (121)). The converter (131) then interfaces with the corresponding controller (115) to transmit the messages to the mobile phones (117).

FIG. 4 shows a method to facilitate an online transaction using an interchange according to one embodiment. In FIG. 4, the user terminal (111) provides (171) account information (121) to the interchange (101) for association with the phone number (123). For example, the user may use a device running a web browser as the user terminal (111) to submit the account information (121) via a secure web connection. The user terminal (111) is typically different from the mobile phone (117). However, in some embodiments, the mobile phone (117) may also be used as the user terminal (111) to submit the account information (121) (e.g., via a wireless application protocol (WAP) application, or via a message sent via short message service (SMS) or multimedia message service (MMS), or via an email message or an instant message).

After the user provides the account information (121) to the interchange (101) for storage in the data storage facility (107), the user can send (177) a charge request to the server (113) of a merchant from the user terminal (111). The server (113) of the merchant can send or redirect (179) the charge request to the interchange (101). In response to the charge request, the interchange (101) sends (173) a confirmation message to the mobile phone (117). If the user sends (173) an approval, or an appropriate reply, to the confirmation message from the mobile phone (117), the interchange (101) communicates with the account server (125) to charge an account of the user identified by the account information (121), without revealing the account information (121) to the server (113). The interchange (101) pays the merchant on behalf of the user using the funds collected via charging the account of the user. For example, the interchange (101) may use its own bank account to pay the merchant operating the server (113). Thus, the financial information of the user is not revealed to the merchant.

Upon the completion of the payment process, the interchange (101) can notify the user via the mobile phone (117) and/or the user terminal (111).

In some embodiments, the server (113) of the merchant redirects the charge request to allow the user terminal (111) to communicate with the interchange (101) to continue the payment process; and the user terminal (111) may provide (171) the account information (121) directly to the interchange (101) after the charge request is redirected.

In alternative embodiments, the user may provide the account information (121) from the mobile phone (117) together with the approval of the charge request.

In one embodiment, the interchange (101) communicates with the mobile phone (117) for the confirmation of the charge request via SMS messages. Alternatively, the confirmation and approval messages can be sent (173) via emails, instant messages, voice message, live calls from operators, etc.

In some embodiments, the user of the mobile phone (117) may choose to fulfill the charge request via the phone bill, instead of charging the account identified by the account information (121). Thus, after the confirmation, the interchange (101) sends the premium messages to the mobile phone (117) to collect funds via the phone bill of the mobile phone (117). In other embodiments, the interchange (101) may send an instruction with the confirmation message to the mobile phone (117) to instruct the user to send mobile originated premium messages to the interchange (101) to collect the funds via the phone bill of the mobile phone (117).

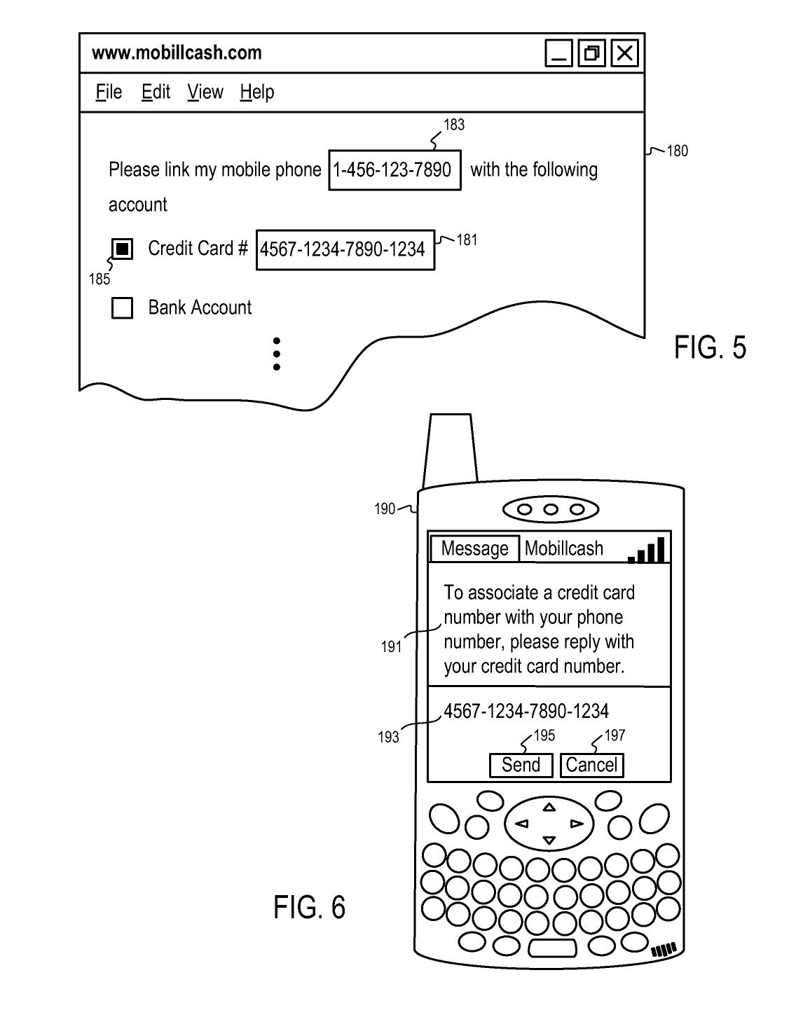

FIG. 5 illustrates a user interface to associate an account with a telephone number according to one embodiment. In FIG. 5, the user interface (180) includes a text field (183) that allows the user to specify the phone number (123) with which the account information (121) provided in the text field (181) is to be associated.

In FIG. 5, the user interface (180) further includes an option list, which allows the user to select various types of accounts, such as credit card accounts, bank accounts, charge card accounts, etc. In the example illustrated in FIG. 5, the checkbox (185) is selected to specify a credit card account.

In some embodiments, the user interface (180) may further present a text field (not shown in FIG. 5) to allow the user to specify an alias for the account information (121) supplied in the text input field (181). For enhanced security, the alias can be used for subsequent communications with the user without revealing the account information (121).

In FIG. 5, the user interface (180) may be presented via a web browser (or a custom application) to submit account information (121) in the text input field (181) from a user terminal (111) to the interchange (101). Alternatively, the account number can be submitted from the mobile phone (117) via a message sent via SMS, WAP, voice mail, or via an interactive voice response (IVR) system.

FIG. 6 illustrates another user interface to associate an account with a telephone number according to one embodiment. In FIG. 6, the user interface (190) is presented on the mobile phone (117) of the user. The user interface (190) presents a message (191) from the interchange (101) to the mobile phone (117) at the phone number (123). The message (191) prompts the user to submit the account information (121) by providing a reply message (193). The user may select the “send” button (195) to provide the account information (121) for association with the phone number (123) or select the “cancel” button (197) to ignore the prompt.

In one embodiment, the messages (191 and 193) are transmitted to the mobile phone (117) via a short message service (SMS). Alternatively, the messages can be transmitted to the mobile phone (117) via other protocols, such as multimedia message service (MMS), email, instant messaging, WAP, voice mail, voice messages via an interactive voice response (IVR) system, etc.

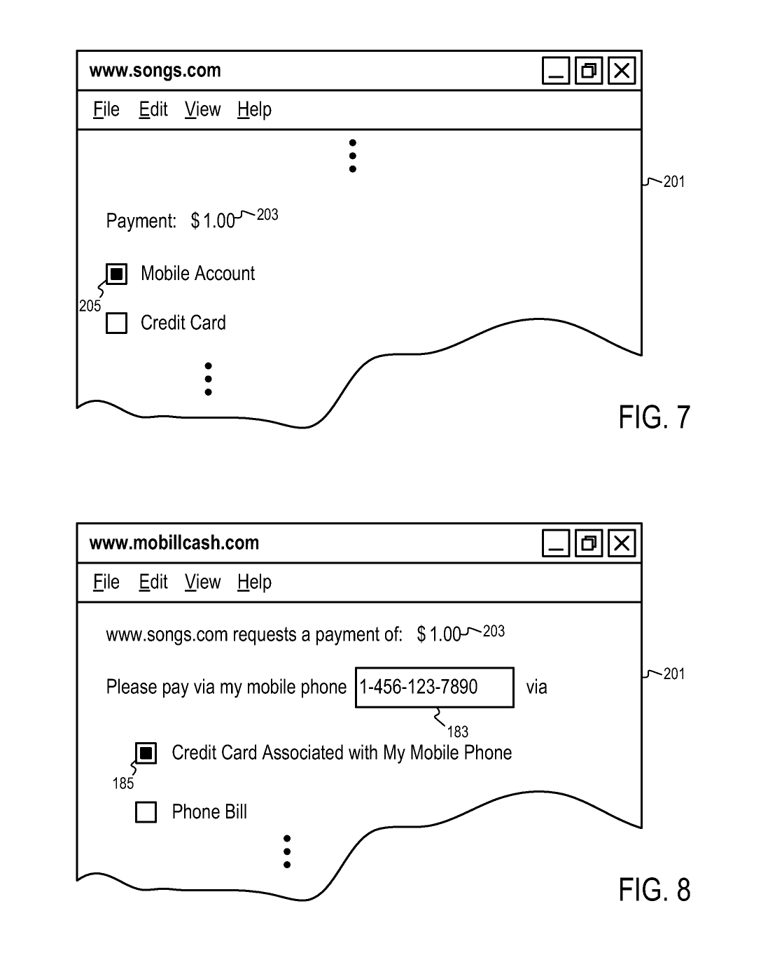

FIG. 7 illustrates a user interface to initiate a payment transaction according to one embodiment. In FIG. 7, the user interface (201) provides an option (205) to request the interchange (101) to process the payment for the amount (203) required to make a purchase from the server (113) of a merchant.

In one embodiment, after the user selects the payment option (205), the server (113) directs the request to the web server of the interchange (101), with a set of parameters to indicate the amount (203), the identity of the merchant, a reference to the purchase, etc. Thus, the user does not have to provide any personal information to the server (113) of the merchant to complete the payment process.

Alternatively, the user may provide the phone number to the merchant to process the payment. Thus, the user does not have to visit the web site of the interchange (101) to complete the payment.

In one embodiment, the server (113) presents the payment option (205) via an online shopping cart system or a third party checkout system. Alternatively or in combination, the server (113) presents the payment option (205) via a web widget. For example, a web widget may include a program code that is portable and executable within a web page without requiring additional compilation. The web widget allows the user to select the option (205) to pay for the product and/or service without leaving the web page or refreshing the web page. In one embodiment, the interchange (101) provides the web widget to facilitate the payment processing.

FIG. 8 illustrates a user interface to initiate a payment request according to one embodiment, after the payment request is redirected to the web site of the interchange (101). In FIG. 8, the user interface (201) includes the identity of the merchant and the amount (203) of the requested payment. The user interface (201) includes a text field (183) to allow the user to provide the phone number (123) to identify the account information (121) via its association with the phone number (123) in the data storage facility (107).

Further, user authentication may be used to reduce false messages to the phone number (123). For example, the user interface (201) may request a PIN for enhanced security. For example, the user may be required to register with the interchange (101) prior to using the services of the interchange (101); and after registering with the interchange (101), the user is provided with the PIN or can created a customized PIN to access the functionality provided by the user interface (201).

Alternatively, the user interface (201) may request an identifier associated with the phone number (123) to initiate the payment transaction. In some embodiments, the user interface (201) requires the user to provide no information other than the phone number (123) in the text field (183) to initiate the transaction.

In FIG. 8, the user interface (201) allows the user to select one option from a plurality of payment options, including paying via the phone bill, and paying via one or more of the accounts identified by the account information (121) associated with the phone number (123) in the data storage facility (107).

In some embodiments, the user interface (201) may present the payment options after authenticating the user (e.g., via a personal identification number or password) for enhanced security.

In some embodiments, the user interface (201) identifies the different accounts represented by the account information (121) by showing aliases of the accounts. The aliases may be previously specified by the user, or be dynamically generated by the interchange (101) based on the types of the accounts and/or portions of the account information (121) (e.g., the first or last few digits of the account number, etc.)

In one embodiment, once the user submits the payment request via the user interface (201), the interchange (101) transmits a confirmation message to the mobile phone (117) according to the phone number (123) provided in the text field (183). In one embodiment, the interchange (101) transmits the confirmation to the mobile phone (117) after the user is authenticated via the user interface (201) to reduce the possibility of unauthorized/unwelcome messages to the mobile phone (117), which may occur when the user intentionally or unintentionally provides an unrelated phone number in the entry box (183).

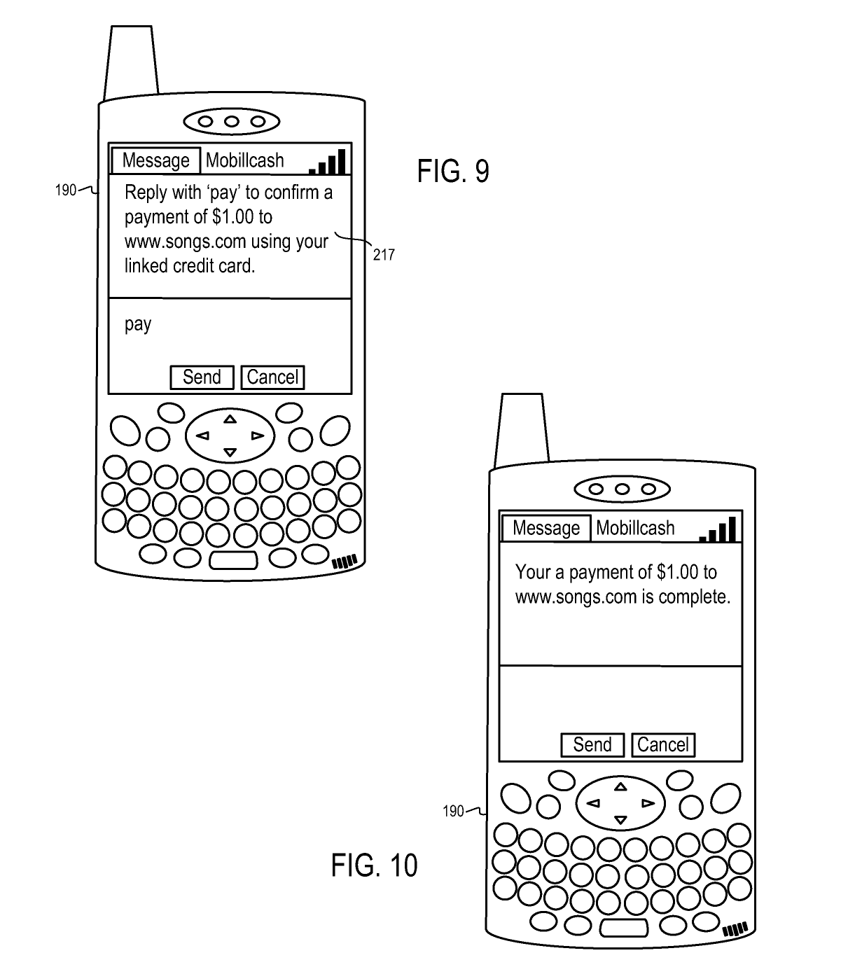

FIG. 9 illustrates a user interface to confirm a payment request according to one embodiment. In FIG. 9, the confirmation message (217) includes the amount (203) of the requested payment and the identity of the payee (e.g., a merchant operating the server (113)).

In one embodiment, the confirmation message (217) includes the instruction to reply with a code, such as a code (e.g., “pay”) provided in the confirmation message (217) as illustrated in FIG. 9.

The presence of the code in the reply message is an indication of the user approving the request; and the requirement for such a code in the reply eliminates false confirmations (e.g., generated via accidental replies or automated replies).

Alternatively or in combination, the requested code may include a PIN associated with the account, and/or a code (not shown) randomly generated and presented in the user interface used to initiate the payment transaction (e.g., user interface (201)).

In some embodiments, the code requested in the text message (217) may be a personal identification number (PIN) associated with the phone number (123). The text message (217) does not include the code; and the knowledge of the code is an indication of the identity of the user. Thus, the use of such a code increases the security of the transaction.

In a further embodiment, the code requested in the text message (217) includes a code that is provided in response to the payment request (e.g., via the user interface (201), not shown in FIG. 8). The code may be generated randomly at the time the request is received via the user interface (201), or when the user interface (201) is presented to the user. The code provided to the user interface (201) can be requested in the reply received from the user interface (190) to indicate that the user who is in possession of the mobile phone (117) has actual knowledge about the payment request submitted via the user interface (201).

After the correct reply is received, the interchange (101) communicates with the account server (125) to electronically charge the user using the account information (121) and pays the payee using the funds collected via communicating with the account server (125). The interchange (101) then notifies the user when the payment transaction is complete.

For example, the interchange (101) may notify the user via a text message to the mobile phone (117), as illustrated in FIG. 10. FIG. 10 illustrates a user interface to confirm the completion of a payment transaction according to one embodiment. No reply to the message that confirms the completion of the payment transaction is necessary. Once the payment transaction is complete, the user would have access to the product purchased via the payment transaction.

In one embodiment, the interchange (101) stores an address of the user associated with the phone number (123). After the completion of the payment transaction, the interchange (101) provides the address to the server (113) of the merchant for the delivery of the purchased product. In some embodiments, the user may provide multiple addresses associated with the phone number (123) and may select one as a delivery address in the confirmation/approve message to the interchange (101). Alternatively, the interchange (101) may receive an address for product delivery from the mobile phone (117) together with the confirmation/approve message and then forward the address to the server (113) of the merchant. Thus, the shipping address of the transaction is verified to be associated with the mobile phone (117). In alternative embodiments, the user may directly provide the shipping address in the website hosted on the server (113) of the merchant.

In other embodiments, the user is provided with the options to pay via the mobile phone bill associated with the phone number (123). The interchange (101) may dynamically calculate a set of premium messages, based on a set of limited number of predetermined prices for premium messages, to match the purchase price. The interchange (101) sends the set of premium messages to the mobile phone (117) at the phone number (123) to collect the funds via the telecommunication carriers to pay for the purchases. Thus, the purchase prices are not limited to the set of predetermined prices for premium messages. In some embodiments, the interchange (101) may send the set of premium messages in a period of time (e.g., a week, a month, a number of mouths, etc.) to spread the payments over the period of time (e.g., to overcome budget limits and/or limits imposed by regulations).

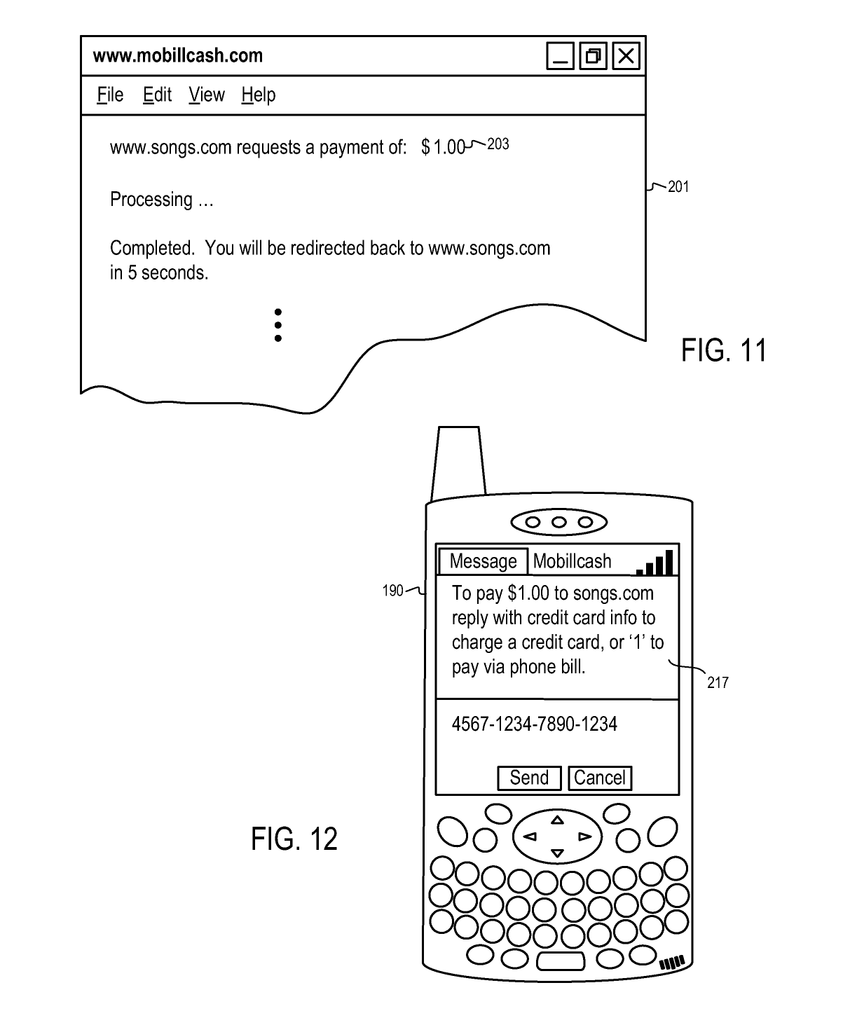

FIG. 11 illustrates a way to redirect a payment confirmation according to one embodiment. For example, after the user submits the payment request to the interchange (101) via the user interface (201) shown in FIG. 8, the interchange (101) may present the user interface (201) illustrated in FIG. 11 to the user. The user interface (201) indicates that the request is being processed; and the user interface (201) is periodically updated to show progress. Once the payment transaction is completed, the user interface (201) provides a confirmation message and may automatically redirect the user back to the website of the payee (e.g., to access the purchased products or services).

In one embodiment, the user is required to provide the approval in response to the confirmation message (217), as illustrated in FIG. 9, within a predetermined period of time. If the user fails to provide the approval from the mobile phone (117) within the predetermined period of time, the payment request may be rejected; and the user interface (201) may present a message indicating the failure and then redirect the user back to the website of the payee.

In some embodiments, instead of redirecting the user back to the website of the payee after the expiration of a predetermined period of time (e.g., after the failure of the payment process, or after the completion of the payment), the user interface (201) may provide a link to the website of the payee to allow the user to manually select the link to go back to the website of the payee to continue the process at the website of the payee.

FIG. 12 illustrates a user interface to receive payment options according to one embodiment. In FIG. 12, the interchange (101) sends a message (217) to the mobile phone (117) to provide a number of options to the user. The message (217) identifies the amount (203) of the requested payment and the identity of the payee (e.g., a merchant operating the server (113)) and asks the user to approve the payment request via a reply that contains a selected payment option.

In FIG. 12, the user may reply with the code “1” to approve the payment request and to pay via the phone bill of the mobile phone (117). Alternatively, the user may reply with the credit card information to charge the payment to a credit card, as illustrated in FIG. 12.

In one embodiment, if the user provides credit card account information in the approval message, the credit card account information is stored and associated with the phone number (123) in the data storage facility (107). Thus, in subsequent approval messages, the user does not have to supply the same information again.

For example, the data storage facility (107) may store account information for each of a plurality of account types (e.g., Visa, MasterCard, checking, savings, etc.) Thus, each of the accounts can be identified to the user via the account type in the confirmation message, without revealing the details of the account information.

For example, the interchange (101) may combine the name of the financial institutions and the type of accounts to generate aliases for the account information.

In some embodiment, the user may define the aliases for the account information by supplying the aliases with the account information (121) for association with the phone number (123).

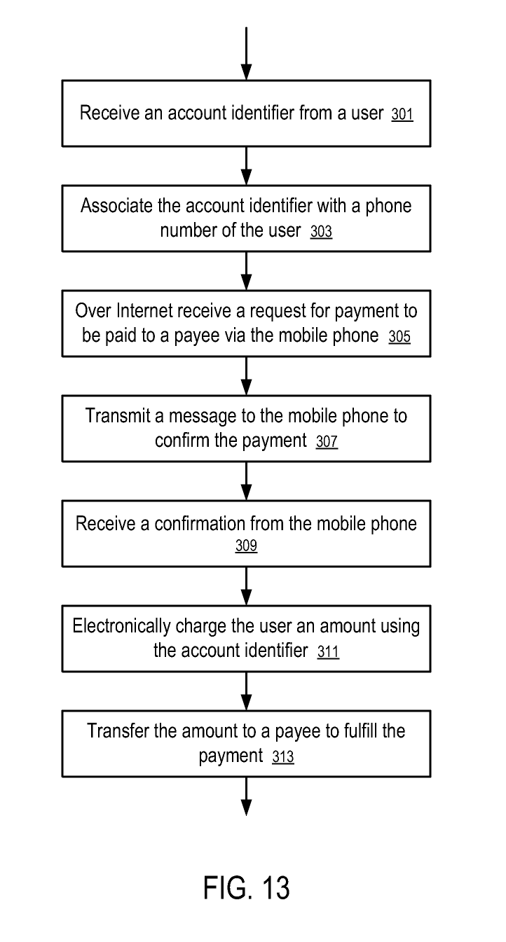

FIG. 13 shows a method to process an online payment according to one embodiment. In FIG. 13, the interchange (101) receives (301) an account identifier (e.g., 121) from a user and associates (303) the account identifier with a phone number (123) of the user in the data storage facility (107). Over the Internet the interchange (101) subsequently receives (305) a request for payment to be paid to a payee via the mobile phone (117) identified by the phone number (123). In response to the request, the interchange (101) transmits (307) a message (217) to the mobile phone (117) to confirm the payment.

After receiving (309) a confirmation or approval from the mobile phone (117) for the payment, the interchange (101) electronically charges (311) the user an amount using the account identifier (e.g., via communicating with the account server (125) using the account identifier). The interchange (101) then transfers (313) the amount to a payee to fulfill the payment.

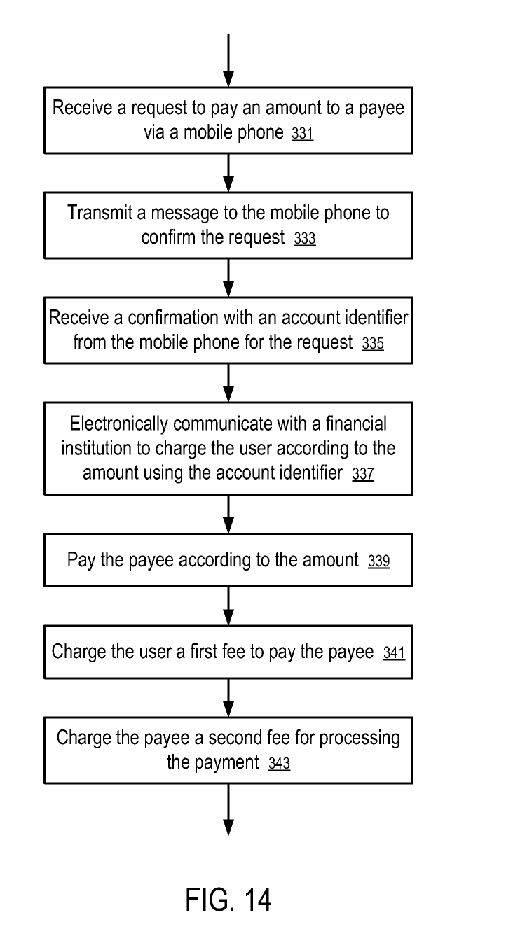

FIG. 14 shows another method to facilitate a payment transaction according to one embodiment. In FIG. 14, the interchange (101) receives (331) a request to pay an amount to a payee via a mobile phone (117). The interchange (101) transmits (333) a message (217) to the mobile phone (117) to confirm the request via the converter (131) corresponding to the controller (115) of the mobile phone (117).

After the interchange (101) receives (335) a confirmation with an account identifier (e.g., 121) from the mobile phone (117) for the request, the interchange (101) electronically communicates (337) with a financial institution to charge the user the specified amount using the account identifier. The interchange (101) pays (339) the payee according to the amount, optionally charges (341) the user a first fee to pay the payee, and optionally charges (343) the payee a second fee for processing the payment.

In one embodiment, the users are given an incentive to provide the account information (121) for electronic payments via the account servers (125). For example, the interchange (101) may charge a lower fee for fulfilling payment requests via the account server (125) than for fulfilling payments requests via the phone bill. For example, the interchange (101) may offer rebates, discounts, etc. to the users who provide the account information (121). In some embodiments, the interchange (101) can complete a payment process via the account server (125) with less restrictions than via the phone bill.

In one embodiment, the merchant may specify the second fee. Different merchants may offer different percentages of the purchase prices as the second fee; and the interchange (101) may calculate the first fee based on the second fee offered by the merchant, by deducting the second fee from the total fees to be charged (e.g., fees charged by the telecommunication carrier for collecting the funds via the mobile phone bill associated with the telephone number and/or the fees charged by the interchange (101) for processing the payments). Since the first fee is charged to the customer (e.g., the purchaser of products and services), the cost to the customer can vary based on the selection of the merchant. For the same purchase prices, the first fee (and thus the cost to the customer) may be different for purchases made via different merchants, because the merchants may offer different percentage of the purchase price as the second fee. In some embodiments, the first and second fees include both fees charged by the telecommunication carrier for collecting the funds via the mobile phone bill/account associated with the phone number (123) and the fees charged by the interchange (101) for processing the payments. In some embodiments, the first fee includes the fees charged by the telecommunication carrier but no fees charged by the interchange (101). In some embodiments, the second fee includes the fees charged by the telecommunication carrier but no fees charged by the interchange (101). In some embodiments, the first fee and/or the second fee do not include the fees charged by the telecommunication carrier. In some embodiments, the first fee is not charged; and in other embodiments, the second fee is not charged.

In one embodiment, the interchange (101) is configured to be linked with a payment intermediary service. For example, the interchange (101) is configured to obtain funds by sending premium messages to the mobile phone (117) of the user and provide the funds to the account of the user at the payment intermediary service. In another example, the interchange (101) is configured to use the account of the user at the payment intermediary service to make payments, when the user provides a telephone number to make a payment via the interchange (101). In some embodiments, the payment intermediary service is operated by an entity distinct and separate from the entity operating the interchange (101). In other embodiments, the payment intermediary service and the interchange (101) are operated by the same entity.

In one embodiment, the payment intermediary service uses the email addresses of the users to identify user accounts (e.g., like the services provided by PayPal™). The payment intermediary service maintains an account balance for the user using a computer system and accepts and processes payment requests using the computer system (e.g., via electronic communications over a network, such as the Internet).

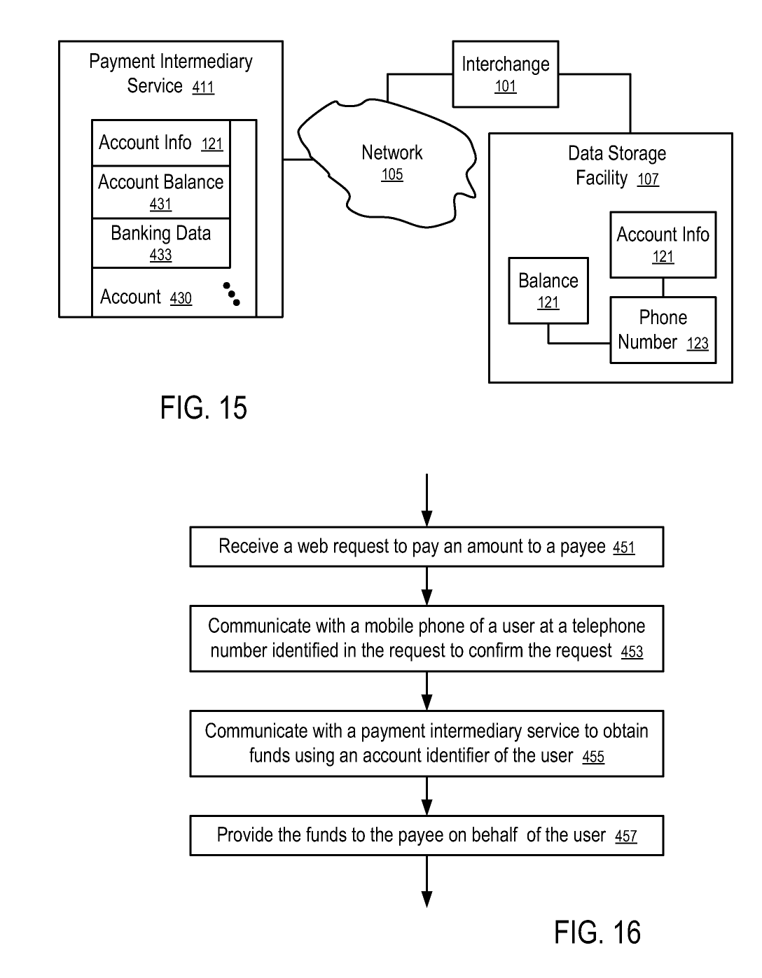

FIG. 15 shows a system to obtain funds according to one embodiment. In FIG. 15, the payment intermediary service (411), running on a computer system, includes accounts for the users. In FIG. 15, the account (430) is used to illustrate an account of one user of the payment intermediary service (411). The account (430) includes account information (121) which identifies the account (430) among other accounts hosted on the payment intermediary service (411).

In one embodiment, the account information (121) uses an email address of the user to identify the account (430). Other types of account identifiers can also be used, such as account numbers, aliases, etc.

In one embodiment, the payment intermediary service (411) maintains an account balance (431) for the account (430). The user may provide the banking data (433) as part of the profile information of the account (430) to allow the payment intermediary service (411) to increase the account balance (431) via electronically debiting the user via the banking data (433) and/or decrease the account balance (431) via electronically crediting the user via the banking data (433).

For example, in one embodiment, the banking data (433) includes an identifier of a bank account. The payment intermediary service (411) is configured to use the identifier of the bank account to transfer funds from the account balance (431) to the bank account in response to the user request to withdraw from the account (430) and deposit into the bank account, or transfer funds from the bank account to the account (430) hosted on the payment intermediary service (411) to fund the account (430) and thus increase the account balance (431).

For example, in one embodiment, the banking data (433) includes an identifier of a credit card account (or a debit card account, or a prepaid card account). The payment intermediary service (411) is configured to use the identifier of the credit card account to transfer funds from the account balance (431) to the credit card account in response to the user request to withdraw from the account (430) and deposit into the credit card account, or transfer funds from the credit card account to the account (430) hosted on the payment intermediary service (411) to fund the account (430) and thus increase the account balance (431).

In one embodiment, the payment intermediary service (411) uses the account balance (431) to make and/or receive payments on behalf of the user. In some embodiments, the payment intermediary service (411) may directly withdraw funds using the banking data (433) to make payments on behalf of the user, without first transferring the funds to the account (430).

In one embodiment, the interchange (101) is configured to store account information (121) that identifies the account (430) of the user at the payment intermediary service (411). The account information (121) is linked to the phone number (123) of the user. The interchange (101) is configured to use funds associated with the phone number (123) to fund the account (430) of the user at the payment intermediary service (411), or to use the account (430) of the user at the payment intermediary service (411) to process payments received at the interchange (101).

In one embodiment, the interchange (101) also maintains a balance (121) associated with the phone number (123). The funds collected for the phone number (123) are stored in the account hosted on the data storage facility (107) and represented by the balance (121). For example, the interchange (101) may obtain the funds via sending premium messages to the mobile phone (117) at the phone number (123), or receiving premium messages from the mobile phone (117) at the phone number (123), or charging the user via the telephone bill of the user at the phone number (123), or charging a credit card (or debit card, or prepaid card, or banking card) identified by the account information (121), or using the account (430) of the user at the payment intermediary service (411).

In one embodiment, the account (430) is also hosted on the data storage facility (107); and the balance (121) may be linked to the account balance (431). For example, the balance (121) and the account balance (431) may be represented by the same data on the data storage facility (107).

In one embodiment, the payment intermediary service (411) is provided at least in part via the interchange (101). Alternatively, the payment intermediary service (411) is provided by a computer system distinct and separate from the interchange (101).

In one embodiment, the user may request the interchange (101) to fund the account (430) via premium messages to the phone number (123). For example, the user may identify the account (430) of the user at the payment intermediary service (411) as a payee, or request the interchange (101) to transfer funds to the account (430) as identified by the account information (121). In response to the user request received via a web interface, the interchange (101) transmits a message to the mobile phone (117) at the phone number (123) to ask the user to confirm the request. If the request received via the web interface is confirmed via communicating with the user through the mobile phone (117), the interchange (101) transmits one or more premium messages to the mobile phone (117) at the phone number (123) to obtain funds via a telecommunication carrier of the mobile phone (117). The interchange (101) then provides the funds to the account (430) of the user at the payment intermediary service (411).

In one embodiment, the user may request the payment intermediary service (411) to obtain funds from the interchange (101) to fund the account (430). The payment intermediary service (411) requests the funds from the interchange, by identifying the phone number (123) (e.g., via an application programming interface of the interchange (101)). The interchange (101) communicates with the mobile phone (117) at the phone number (123) to confirm the transaction. After the transaction is confirmed, the interchange (121) may use the balance (121) to provide the requested funds, and/or transmit one or more premium messages to the mobile phone (117) at the phone number (123) to collect the requested funds (or use other funds associated with the phone number (123)).

In one embodiment, the account (430) stores the phone number (123) of the user. When the user uses the payment intermediary service (411) to make a payment and the account balance (431) is not sufficient to cover the payment, the payment intermediary service (411) is configured to request funds from the interchange (101) using the phone number (123). The interchange (101) is to provide the funds after confirming with the user via communicating with the mobile phone (117) at the phone number (123).

In one embodiment, the interchange (101) communicates with the mobile phone (117) to confirm the transaction by verifying a code, such as a PIN or a transaction code specific to the request.

For example, in one embodiment, the interchange (101) sends a message (e.g., an SMS message, a voice message, an instant message, an email, a text message, a Multimedia Messaging Service (MMS) message, etc.) to the mobile phone (117) at the phone number (123) to request the user to reply to the message via the mobile phone (117) and provide the PIN of the user in the reply. If the interchange (101) receives the correct the PIN in the reply, the request is confirmed; otherwise, the request may be rejected.

In one embodiment, the interchange (101) is configured provide a transaction code (e.g., a one time code) to the user in the message sent to the mobile phone (117) and request the user to provide the code back to the interchange (101) (e.g., via a web site of the interchange (101)) to confirm the transaction.

In another embodiment, the interchange (101) is configured to provide a transaction code to the user via a web confirmation of the transaction request and request the user to provide the transaction code back to the interchange (101) via the mobile phone (117) at the phone number (123) to confirm the transaction. The user may provide the transaction code via an SMS message from the mobile phone (117), a voice call from the mobile phone (117) to an interactive voice response (IVR) system of the interchange (101), an email or instant message from the mobile phone (117), or a web request from the mobile phone (117).

In one embodiment, the interchange (101) authenticates the user before initiating the communication with the mobile phone (117) at the phone number (123). In one embodiment, the interchange (101) requests the user to initiate a communication using the mobile phone (117) (e.g., by providing a transaction code to the interchange (101) via a message from the mobile phone (117)).

FIG. 16 shows a method to process a payment request according to one embodiment. In FIG. 16, the interchange (101) receives (451) a web request to pay an amount to a payee (e.g., a merchant server (113)). In response to the web request, the interchange (101) communicates (453) with a mobile phone (117) of a user at a telephone number (123) identified in the request to confirm the request. After the request is confirmed via communication with the mobile phone (117), the interchange (101) communicates (455) with a payment intermediary service (411) to obtain funds using an account identifier of the user with the payment intermediary service (411). The interchange (101) provides (457) the funds to the payee on behalf of the user.

In one embodiment, the account identifier is identified by the account information (121) stored in the data storage facility (107) of the interchange (101); and the interchange (101) looks up the account identifier based on the phone number (123) identified in the request.

In some embodiments, the account identifier is provided in the request, or during the communication with the mobile phone (117) to confirm the request.

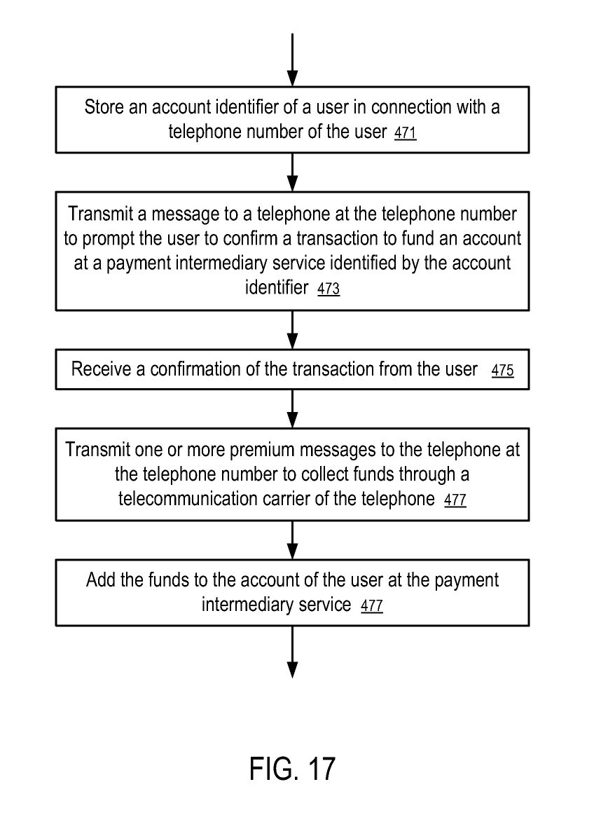

FIG. 17 shows a method to fund an account according to one embodiment. In FIG. 17, the interchange (101) is configured to store (471), in the data storage facility (107), an account identifier of a user (e.g., as part of the account information (121)) in connection with a telephone number (123) of the user. In one embodiment, the account identifier is an email address of the user.

The interchange (101) is configured to transmit (473) a message to a telephone (117) at the telephone number (123) to prompt the user to confirm a transaction to fund an account (430) at a payment intermediary service (411) identified by the account identifier.

After the interchange (101) receives (475) a confirmation of the transaction from the user, the interchange (101) transmits (477) one or more premium messages to the telephone (117) at the telephone number (123) to collect funds through a telecommunication carrier of the telephone (117) and adds (477) the funds to the account (430) of the user at the payment intermediary service (411).

In one embodiment, the interchange (101) is configured to maintain a balance (431) of the account (430) for the user at the payment intermediary service (411).

In one embodiment, the account (430) of the user at the payment intermediary service (411) is funded by at least one of: a bank account and a credit card account, using the banking data (433).

In one embodiment, the account identifier is received during the communicating with the telephone (117) to confirm the request.

In one embodiment, the interchange (101) is configured to authenticate the user before transmitting the message to the telephone (117).

In one embodiment, the interchange (101) is configured to receive a request for a payment on behalf of the user via a web site. The request identifies the telephone number (123) of the user. In response to the request, the interchange (101) transmits a message to a telephone (117) at the telephone number (123) of the user to prompt the user to confirm the request for the payment. In response to the request being confirmed via the computer communicating with the telephone (117), the interchange (101) electronically communicates with the payment intermediary service (411) to obtain funds from the account (430) of the user at the payment intermediary service (411) using the account identifier, and provides/fulfills the payment on behalf of the user using the funds obtained from the payment intermediary service (411).

In one embodiment, the interchange (101) maintains a balance (121) for the user in connection with the telephone number (123) of the user. In response to a confirmation with the user via communicating with the telephone (117), the interchange (101) obtains funds from the payment intermediary service (411) via the account identifier to increase the balance.

In one embodiment, the balance (121) is funded at least in part via a telephone bill for the telephone number (123).

In one embodiment, the interchange (101) is configured to present a payment option page to the user in response to a web visit from the user redirected from a web server (113) of a payee. The payment option page includes an entry to receive the telephone number (123) to identify the user. The interchange (101) is configured to redirect the user back to the web server (113) of the payee upon completion of the payment.

In one embodiment, the interchange (101) is configured to present a plurality of payment options to the user in response to the user providing the telephone number (123) in the payment option page. The plurality of payment options may include charging the user according to the account identifier and charging the user via a bill for the telephone number (123).

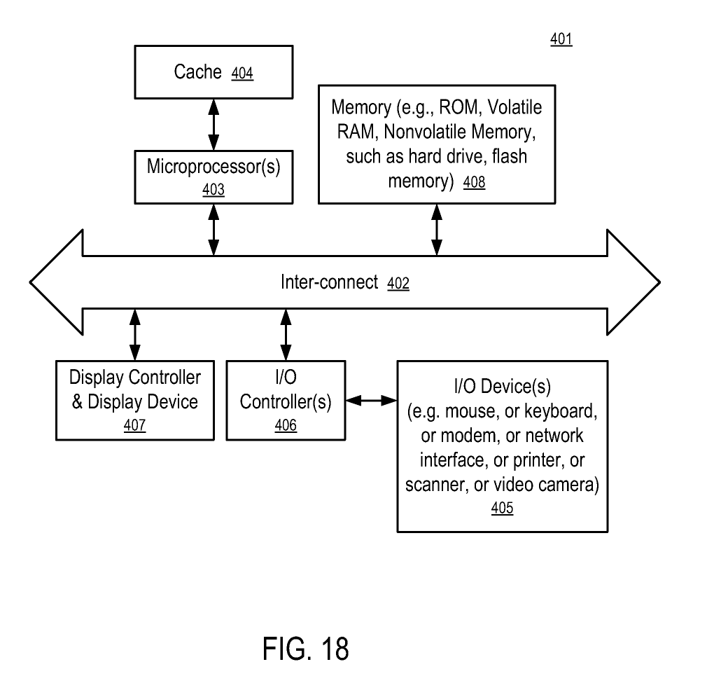

FIG. 18 shows a data processing system, which can be used in various embodiments. While FIG. 18 illustrates various components of a computer system, it is not intended to represent any particular architecture or manner of interconnecting the components. Some embodiments may use other systems that have fewer or more components than those shown in FIG. 18.

In one embodiment, each of the interchange (101), the data storage facility (107), the controllers (115), the mobile phones (117), the user terminals (111), the account server (125) and the servers (113) can be implemented as a data processing system, with fewer or more components, as illustrated in FIG. 18.

In FIG. 18, the data processing system (401) includes an inter-connect (402) (e.g., bus and system core logic), which interconnects a microprocessor(s) (403) and memory (408). The microprocessor (403) is coupled to cache memory (404) in the example of FIG. 18.

The inter-connect (402) interconnects the microprocessor(s) (403) and the memory (408) together and also interconnects them to a display controller, display device (407), and to peripheral devices such as input/output (I/O) devices (405) through an input/output controller(s) (406).

Typical I/O devices include mice, keyboards, modems, network interfaces, printers, scanners, video cameras and other devices which are well known in the art. In some embodiments, when the data processing system is a server system, some of the I/O devices, such as printer, scanner, mice, and/or keyboards, are optional.

The inter-connect (402) may include one or more buses connected to one another through various bridges, controllers and/or adapters. In one embodiment, the I/O controller (406) includes a USB (Universal Serial Bus) adapter for controlling USB peripherals, and/or an IEEE-1394 bus adapter for controlling IEEE-1394 peripherals.

The memory (408) may include ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a tangible machine readable medium includes any apparatus that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
storing, by the computer, an account identifier of a user in connection with a telephone number of the user, the account identifier comprising an email address of the user to identify an account of the user at a payment intermediary service;
transmitting a message to a telephone at the telephone number of the user to prompt the user to confirm a transaction to fund the account via the telephone;
in response to the transaction being confirmed via communicating with the telephone, transmitting one or more premium messages to the telephone at the telephone number to collect funds through a telecommunication carrier of the telephone; and
adding the funds to the account of the user at the payment intermediary service.

2. The method of claim 1, further comprising:
maintaining, by the computer, a balance of the account for the user at the payment intermediary service.

3. The method of claim 2, wherein the account of the user at the payment intermediary service is funded by at least one of: a bank account and a credit card account.

4. The method of claim 1, wherein the telephone comprises a mobile phone; and the message is transmitted to the mobile phone via short message service (SMS).

5. The method of claim 1, wherein the message includes one of: a voice message, a text message, an email message, and an instant message.

6. The method of claim 1, wherein the account identifier is received during the communicating with the telephone to confirm the request.

7. The method of claim 1, further comprising:
authenticating the user before transmitting the message to the telephone.

8. The method of claim 1, wherein the communicating with the telephone comprises:
prompting the user to provide a correct code to confirm the request.

9. The method of claim 8, wherein the code comprises a personal identification number (PIN) associated with the telephone number.

10. The method of claim 8, wherein the user is prompted to provide the code via the telephone.

11. The method of claim 10, further comprising:
transmitting the correct code to the user via a web site through which a request for the transaction is received, prior to the prompting.

12. The method of claim 8, further comprising:
providing the user the correct code in the message, wherein the user is prompted to provide the code via a web site through which the request is received.

13. The method of claim 1, further comprising:
receiving at the computer a request for a payment on behalf of the user, the request identifying the telephone number of the user;
in response to the request, transmitting a message to the telephone at the telephone number of the user to prompt the user to confirm the request for the payment;
in response to the request being confirmed via the computer communicating with the telephone, electronically communicating, by the computer, with the payment intermediary service to obtain funds from the account of the user at the payment intermediary service using the account identifier; and
providing, by the computer, the payment on behalf of the user using the funds obtained from the payment intermediary service.

14. The method of claim 13, further comprising:
maintaining, by the computer, a balance for the user in connection with the telephone number of the user; and
in response to a confirmation with the user via communicating with the telephone, obtaining funds from the payment intermediary service via the account identifier to increase the balance.

15. The method of claim 14, wherein the balance is funded at least in part via a telephone bill for the telephone number.

16. The method of claim 13, further comprising:
presenting a payment option page to the user in response to a web visit from the user redirected from a web server of a payee, the payment option page including an entry to receive the telephone number to identify the user; and
redirecting the user back to the web server of the payee upon completion of the payment.

17. The method of claim 16, further comprising:
presenting a plurality of payment options to the user in response to the user providing the telephone number in the payment option page, the plurality of payment options including charging the user according to the account identifier and charging the user via a bill for the telephone number.

18. A computer-readable storage media storing instructions, the instructions causing a computer to perform a method, the method comprising:
storing, by the computer, an account identifier of a user in connection with a telephone number of the user, the account identifier comprising an email address of the user to identify an account of the user at a payment intermediary service;
transmitting a message to a telephone at the telephone number of the user to prompt the user to confirm a transaction to fund the account via the telephone;
in response to the transaction being confirmed via communicating with the telephone, transmitting one or more premium messages to the telephone at the telephone number to collect funds through a telecommunication carrier of the telephone; and
adding the funds to the account of the user at the payment intermediary service.

19. A system, comprising:
a data storage facility to store and associate an account identifier of a user with a telephone number of the user, the account identifier identifying an account of the user at a payment intermediary service, the account identifier comprising an email address of the user; and
an interchange coupled with the data storage facility, the interchange including a common format processor and a plurality of converters to interface with a plurality of controllers, the converters configured to communicate with the controllers in different formats, the converters to communicate with the common format processor in a common format, the common format processor to instruct a first controller of the controllers, via a first converter of the converters, to transmit a message to a telephone at the telephone number of the user, the message to prompt the user to confirm a transaction to fund the account via the telephone, in response to the transaction being confirmed via communicating with the telephone, the common format processor to transmit, via the first converter, one or more premium messages to the telephone at the telephone number to collect funds through a telecommunication carrier of the telephone and to add the funds to the account of the user at the payment intermediary service.

20. The system of claim 19, wherein the common format processor further includes a mobile message generator.
